(19) United States
(12) Patent Application Publication
(10) Pub. No.: US 2014/0280300 A1
(43) Pub. Date: Sep. 18, 2014

(54) GUIDED DATA COLLECTION MANAGEMENT SYSTEM

(71) Applicants: Robin Ottenfelt, Vallda (SE); Mark D. Hinckley, Malvern, PA (US); Rasmus Höglund, Kungsbacka (SE); Samir Dalili, Goteborg (SE)

(72) Inventors: Robin Ottenfelt, Vallda (SE); Mark D. Hinckley, Malvern, PA (US); Rasmus Höglund, Kungsbacka (SE); Samir Dalili, Goteborg (SE)

(73) Assignee: AKTIEBOLAGET SKF

(21) Appl. No.: 13/836,093

(22) Filed: Mar. 15, 2013

(51) Int. Cl. G06F 17/30

(52) U.S. Cl. CPC G06F 17/30386
USPC 707/769

(57) ABSTRACT

A computing system having a server including a processor and configured to communicate with a plurality of remote devices via a network is provided. The system includes an application database accessible to the server and having application indices, and at each application indices, the application database stores information related to an operating environment of one of the plurality of remote devices.

The system further including a workflow database accessible to the server and providing workflow indices, the workflow database stores a workflow, the workflow including activities and required inputs; an input database accessible to the server and having input indices; and a master database accessible to the server and comprising master indices, wherein the master database stores information linking one of the input indices of the input database with one of the plurality of remote devices and with one of the workflow indices of the workflow database.

### TECHNICAL FIELD

The present disclosure relates to a data collection and management system.

### BACKGROUND

Data collection and management in various industries can be used to create reports, product lists, etc., which may then be used internally for analysis, asset tracking, etc., and/or sent to vendors, service provides, customers, or others, so that a particular product or service can be purchased. In many cases, the type and/or quality of the data collected can affect the accuracy and/or efficiency of such activities. Furthermore, identifying appropriate entities to take action pursuant to the data collected may also be a challenge, oftentimes requiring a review of the request and a determination of where to send such a request or reference to a secondary system.

For example, in a failure analysis situation, an end-user may report a failure to a vendor, who may be obligated to repair or replace the failed part. In some cases, this may proceed by the end-user tearing down the system to expose the failed part, and then taking a picture of or removing the failed part, and sending the part or the picture to the vendor as proof that a replacement is required. However, it may be in the vendor's and/or the end-user's interest to ensure such a part failure is not due to improper implementation and/or operating conditions. If only evidence of the actual failure is provided, and not a more “forensic” type of analysis of the conditions as they existed at the time of the malfunction/breakdown, the result may be an incomplete and/or unreliable understanding of the breakdown and/or a requirement that service personnel or engineers travel to the site to investigate.

Furthermore, in inspection situations, for example, an end-user may be required to conduct systems audits to ensure compliance with certain standards, e.g., those set by the International Organization for Standardization (ISO), or others. However, determining the correct standard and ensuring that the correct information is gathered and documented may be cumbersome and may raise the possibility of improper validation or failing to meet standards, i.e., when the incorrect standard is applied. Moreover, an organization seeking standardization approval can be constrained by a lack of information as to what is required by the correct standard, so that the correct actions, documentation, etc., can be collected in advance of the validation. A variety of other situations will be apparent in which data collection is employed, especially in an industrial context.

### SUMMARY

Embodiments of the disclosure may provide a method of collecting data. The method includes receiving a request for a workflow from a remote device. The request includes information indicative of a goal for the workflow and an object associated with the workflow. The method also includes selecting, using a processor, the workflow from a plurality of workflows. The workflow includes instructions for conducting a plurality of activities. The method also includes transmitting the workflow to the remote device, and receiving a workflow report comprising inputs received in response to plurality of activities of the workflow, from the remote device. The method further includes selecting one or more potentially-interested entities based on the workflow report, the goal, the object, or a combination thereof, and transmitting data based on the workflow report to the one or more potentially-interested entities that are selected. The method also includes receiving one or more responsive actions from at least one of the one or more potentially-interested entities.

Embodiments of the disclosure may also provide a computing system. The computing system includes a server that includes a processor and is configured to communicate with a plurality of remote devices via a network. The system also includes an application database accessible to the server and comprising application indices. At each of the application indices, the application database stores information related to an operating environment of one of the plurality of remote devices. The system further includes a workflow database accessible to the server and comprising workflow indices. At each of the workflow indices, the workflow database stores a workflow, the workflow including activities and required inputs. The system also includes an input database accessible to the server and including input indices. At each of the input indices, the input database stores input received from at least one of the plurality of remote devices executing a workflow. The system also includes a master database accessible to the server and including master indices. At each of the master indices, the master database stores information linking one of the input indices of the input database with one of the plurality of remote devices and with one of the workflow indices of the workflow database.

Embodiments of the disclosure may also provide a method for collecting data. The method includes receiving a workflow input using a processor of a computing device, and selecting a workflow based on the workflow input, the workflow comprising a plurality of activities. The method also includes instructing a user to carry out at least one of the plurality of activities of the workflow that is selected, with at least some of the plurality of activities including providing an activity input. The method further includes receiving the activity input in response to instructing the user, and adjusting, using the processor, the workflow based on the activity input.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a schematic view of a data collection and management system, according to an embodiment

FIG. 2 illustrates a flowchart of a method for data collection and management, according to an embodiment.

FIG. 3 illustrates a display of the remote device, showing a workflow dashboard, according to an embodiment.

FIG. 4 illustrates a display of the remote device, showing an instruction screen and input tracking, according to an embodiment.

FIG. 5 illustrates a flowchart of another method for data collection and management, according to an embodiment.

FIG. 6 illustrates a schematic view of databases for use in a specific example implementation of the methods of FIG. 2 and FIG. 4, according to an embodiment.

FIG. 7 illustrates a schematic view of a processor system, according to an embodiment.

### DETAILED DESCRIPTION

The following detailed description refers to the accompanying drawings. Wherever convenient, the same reference numbers are used in the drawings and the following description to refer to the same or similar parts. While several exemplary embodiments and features of the present disclosure are described herein, modifications, adaptations, and other implementations are possible, without departing from the spirit and scope of the present disclosure. Accordingly, the following detailed description does not limit the present disclosure. Instead, the proper scope of the disclosure is defined by the appended claims.

In general, the present disclosure relates to systems and methods for providing an integrated, guided approach to data collection and management, e.g., in an industrial context. The systems and methods may facilitate efficient identification of workflows to sequentially guide a user through various analyses to arrive at a stated goal. Further, the systems and methods may facilitate on-the-fly adjustments of the workflow, or may even adjust the goal and substitute a new workflow configured to achieve the adjusted goal, in response to inputs received in response to the instructions to a user.

In various specific implementations, the systems and methods may facilitate correct identification of suitable parts and products, correct selection of inspections, e.g., for determining standards compliance, conducting the selected inspections, and may guide a failure analysis to provide a reliable dataset to facilitate identification of failure causes, remedial actions, replacement parts, etc. Additional contexts into which the disclosed methods and systems may be applied will be readily apparent to one of skill in the art. Furthermore, the systems and methods of the present disclosure may analyze the inputs and distribute information to appropriate entities, facilitating appropriate responsive actions to data collected as part of the workflows. Moreover, the systems and methods provide a centralized repository for information collected, which may provide for redundancy, long-term access, multiple-user access, and the ability to revise and/or reuse information, and/or the like.

Referring now to the specific, depicted examples, FIG. 1 illustrates a simplified conceptual schematic view of a data collection and management system (hereinafter, “system”) 100, according to an embodiment. The system 100 generally includes one or more remote devices, for example, a mobile device 102 and a computer 104. As used herein, the term “mobile device” may refer to any type of mobile or standalone device, including any combination of hardware and software, capable of supporting the functionalities and data processing/transmitting techniques discussed herein. For example, the mobile device 102 may be a mobile phone, a tablet device, a notebook device, a personal data assistant (PDA), or the like. In some cases, the mobile device 102 may be “ruggedized” i.e., disposed within a protective case designed to protect the mobile device 102 from impact, dirt, liquids, shock, etc.

The mobile device 102 may be configured to receive input from one or more input peripheral components 103 and, likewise, the computer 104 may be configured to communicate with one or more input peripheral components 105. The input peripheral components 103, 105 may communicate with the mobile device 102 and the computer 104, respectively, via any suitable communications link, such as a USB connection, a wireless link such as Bluetooth, infrared ports, physical transfer of memory storage (e.g., flash disks) etc. Accordingly, the mobile device 102 and the computer 104 may be configured to send commands and/or queries to the input peripheral components 103, 105, respectively, and receive input data therefrom. In various embodiments, the input peripheral component 103, 105 may each include one or more stylus pens, flatness sensors, temperature sensors (e.g., infrared), pressure sensors, cameras, microphones, keyboards, mice, position-sensing gloves, stereo-optical sensors, voltage meters, current meters, resistivity meters, gyroscopes, velocity sensors, accelerometers, position sensors, vibration sensors, magnetic field sensors, GPS devices, and/or other types of sensors, probes, and the like. Furthermore, in some cases, the input peripheral components 103, 105 may be integrated into the mobile device 102 and computer 104, respectively. For example, the mobile device 102 and/or the computer 104 may include a touchscreen as one of the input peripheral components 103 and/or 105, and/or the mobile device 102 and/or the computer 104 may include a camera integrated therein and serving as one of the input peripheral components 103, 105.

The system 100 may also include one or more servers, for example, a cloud server 106. The cloud server 106 may be coupled with one or more other servers, for example, and may thus provide access to operating systems, processor time, memory storage, or any other attribute of another server, computing system, or the like. The cloud server 106 may be connected to the mobile device 102 and/or the computer 104 by a data communications link, e.g., via a network 110, as shown. The network 110 may be or include a wireless network. Such networks may include wireless Ethernet, Global System for Mobile Communications (GSM), Enhanced Data rates for GSM Evolution (EDGE), Universal Mobile Telecommunications System (UMTS), Worldwide Interoperability for Microwave Access (WiMAX), Long Term Evolution (LTE), etc. The network 110 may additionally or instead include a wired network. Further, the network 110 may operate according to any protocol, standard, structure, and/or technique, including Ethernet, a virtual personal network (VPN), a secured or unsecured communications link using any suitable protocol (e.g., TCP/IP, UDP, SOAP, etc.), and/or the like. In some cases, the network 110 may be representative of two or more types of communications links, which may allow the transmission of data between the mobile device 102, the computer 104, the cloud server 106, and/or other devices. Furthermore, the network 110 may enable data transmission in via a web browser, a remote terminal, virtual personal network, email, and/or the like. It will be readily appreciated that various other servers may be included in one or more implementations of the system 100, with the illustrated embodiment being one among many contemplated.

The mobile device 102 and the computer 104, in at least one embodiment, may be configured to communicate directly with one another, e.g., via a suitable communication (wired or wireless) link. For example, the mobile device 102 may be configured to transmit newly-collected information from the input peripheral 103 to the computer 104, either as raw data or as a packaged, summarized, or otherwise analyzed report. Further, in some cases, the mobile device 102 and the computer 104 may be communicable via interaction with the cloud server 106 over the network 110, such that, from the perspective of the mobile device 102 and/or the computer 104, the cloud server 106 serves as the central repository of data.

The cloud server 106 may provide a virtual machine that may interact with either or both of the mobile device 102 and the computer 104. In some cases, the cloud server 106 may provision and initiate a virtual machine, allowing a user of the mobile device 102 and/or the computer 104 to remotely control an operating system and/or control one or more applications executing on the cloud server 106 or another computing system. In some embodiments, the cloud server 106 may additionally or instead communicate with the mobile device 102 and/or the computer 104 via email, SMS text messaging, or may be accessible and interact with the mobile device 102 and the computer 104 via a website which may include one or more applications executable in a web browser. A variety of other such interactive communication and data transmission processes and protocols are known and are contemplated for use in the system 100.

The cloud server 106 may further store login credentials (e.g., username, password, security certificates, etc.) for one or more mobile devices 102, one or more computers 104, and/or one or more other devices. Accordingly, the cloud server 106 may allow multiple users to access, add, alter or otherwise manage information on the cloud server 106, facilitating data sharing among organizations employing the system 100.

The system 100 may also include one or more databases 112, 114, 116, 118, and 120. In some implementations, two or more of the databases 112-120 may be contained in a single database. The databases 112-120 may be organized in any suitable structure. The databases 112-120 may be stored on memory hardware internal to the cloud server 106, or may be located externally to the cloud server 106, for example, remotely located with respect thereto and accessible via a communications link, USB connection, etc.

More particularly, the databases 112-120 may be or include an application database 112, an input database 114, a workflow database 116, a master database 118, and an entity database 120, with each database including elements or “indices.” For example, each index of the application database 112 may store information related to the application and/or mobile device 102, e.g., the operating environment thereof. The input database 114 may store inputs received during a workflow. The workflow database 116 may store available workflows. The master database 118 may logically link the index of the input database 114 with the mobile device 102, computer 104, and/or an appropriate index or indices of one or both of the workflow database 116 and the application database 112.

The cloud server 106 may communicate with one or more potentially-interested entities 122, 124, 126, represented for the sake of illustration as computers. The potentially-interested entities 122-126 may be human operators, servers, computers, networks, or the like. In some cases, the potentially-interested entities 122-126 may be business or engineering groups within an organization such as an original equipment manufacturer (OEM) for a certain part, machine, or structure, a repair or service vendor, a distributor, etc. The entity database 120 may contain links to each of the entities 122-126, and may associate each with areas or subject-matter of interest, i.e., areas in which the entities 122-126 may be helpful, provide a service, or otherwise productively use information. Information may be transmitted from the mobile device 102 and/or the computer 104, interpreted, analyzed, or simply received by the cloud server 106, and then passed to the potentially-interested entities 122-126, e.g., according to data stored in the entity database 120.

Turning now to the operation of the various components of the system 100, with continuing reference to FIG. 1, FIG. 2 illustrates a method 200 for collecting data, according to an embodiment. The method 200 may operate, for example, using the computer 104 and/or the mobile device 102 receiving data and interacting with the cloud server 106 via the network 110. For purposes of illustration, the method 200 will be described in terms of operation of the mobile device 102; however, it will be appreciated that some or all aspects of the method 200 may apply equally to the computer 104 and/or any other suitable device, and is not limited to an implementation on any particular machine, unless otherwise expressly stated herein.

The method 200 may begin by the mobile device 102 receiving an input indicative of a type of an object being analyzed, as at 202. The object being analyzed may, in some embodiments, be an industrial machine such as a pump, turbine, compressor, engine, motor, etc. In other cases, the device being analyzed may be a static structure, such as a section of railway, a bridge, a building, etc. In other embodiments, the object being analyzed may be one part of a machine or static structure, for example, a bearing, beam, fastener, etc. The input may be received at 202, for example, by a user selecting the type of object from a drop-down menu, series of drop-down menus, by text entry of a name, model, etc. or by choosing or ranking a plurality of selections. In some cases, the input received at 202 may be a photograph, video, or an audio input describing the structure, or the sound of the object operation (in the case where the object is a machine). In some embodiments, the mobile device 102 may identify the type of object based on the input at 202. However, in other embodiments, the mobile device 102 may send the raw or compressed input data to another device (e.g., the computer 104 and/or the cloud server 106) for analysis and identification of the object.

The mobile device 102 may also query a user for data indicative of a workflow, as at 204. A workflow may be a set of activities that are conducted to achieve a stated goal. Accordingly, one example of a workflow may be analyzing a failed part to determine how to correct the failure and/or avoid a repeated incidence of the failure. Anther workflow may be collecting and documenting operations data for compliance with industry and/or original equipment manufacturer (OEM) standards, or the like. Still another workflow may be determining a suitable and efficient part or product to be used in a particular machine. Additional details of such examples of workflows are discussed below. Accordingly, the mobile device 102 may request that the user specify what workflow is to be accomplished.

With the object and the workflow identified, the mobile device 102 may search a database containing a plurality of workflows associated with various types of objects, as at 206. The database may be the workflow database 116, which may store each of the available workflows. Accordingly, searching the database may include sending a request to the cloud server 106 and receiving a response therefrom, after the cloud server 106 accesses and searches or causes the workflow database 116 to be searched. In other embodiments, the mobile device 102 and/or the computer 104 may store the workflow database 116, or, for example, a portion of the workflow database 116, e.g., those workflows that have been previously employed by the user, has identified as of interest, those associated with objects the user is known to employ, and/or any other subset of the workflows. As such, searching the database may include the mobile device 102 first searching the workflows it has direct access to and, failing to find an appropriate workflow locally, sending a request to the cloud server 106.

In either example case, the mobile device 102 may make a determination as to whether a workflow is found that matches the parameters (e.g., object and stated goal) of the desired workflow is found, as at 208. An affirmative determination may result from receiving a workflow in response to a request sent to the cloud server 106. In other cases, an affirmative determination may result from finding a matching workflow on the database stored locally on the mobile device 102 and/or on the computer 104. On the other hand, a negative determination may result from receiving a “not found” message from the cloud server 106, or a request for adjusted workflow parameters, and/or by completing a search of the workflow database stored locally on the mobile device 102, the computer 104, or elsewhere that is directly accessible to either. Moreover, in some cases, the cloud server 106 may deliver and/or the mobile device 102 may find one or more nearest matches, once having determined that a precisely matching workflow is not found at 208. The mobile device 102 may then display the nearest matching workflows and allow the user to determine which, if any, is appropriate. If one is selected as appropriate, the negative determination at 208 may become an affirmative determination; otherwise, the negative determination may stand.

When the mobile device 102 determines that a matching or otherwise suitable workflow has not been found (i.e., a negative determination), the method 200 may return to querying the user for data indicative of the workflow, as at 204. That is, the method 200 may request altered workflow parameters, in an effort to redefine the search parameters and identify a workflow that may be suitable.

When the mobile device 102 makes an affirmative determination at 208, the method 200 may, in one embodiment, proceed to the mobile device 102 outputting a list of resources, documentation, input peripheral components, other equipment, etc., that are likely to be required in performing the workflow, as at 210. This may facilitate a user completing the workflow efficiently, rather than putting together necessary resources, etc., ad hoc. In other cases, such an upfront indication may not be necessary and may be omitted.

Further, in at least one embodiment, the method 200 may include displaying a dynamic completion indicator, as at 212, for example, to provide a quick, visual reference of the percentage of the workflow completed. At the initialization of the workflow, i.e., after the workflow has been selected but not yet conducted, this visual display may show a zero completion. FIG. 3 illustrates a workflow dashboard of the mobile device 102, with several visual completion indicators 300, 302, 304, 306, 308 at various stages of workflow completion. As shown, the mobile device 102 may facilitate multiple in-progress workflows at once, with some being incomplete, and others being complete or not yet started. For example, the illustrated mobile device 102 is implementing five workflows, as illustrated in workflow visualizations 310, 312, 314, 316, 318. The workflow visualizations 310-318 may summarize workflow completion status (as indicated by dynamic completion indicators 300-308), indicate whether photographs or other inputs have been associated with the workflow, and/or provide additional workflow identification information, such as the title of the workflow, object to which it relates, serial number, operator, etc.

Referring again to FIG. 2, the mobile device 102 with the workflow loaded may proceed to instructing the user to carry out an activity of the workflow, as at 214. The activity may include one or more operations, documentation (e.g., inputs, photographs, etc.), and/or the like that may be required. In one specific example, a failure analysis workflow, the instructions may indicate what pieces, and how, to take apart a machine in a stepwise or incremental fashion and what documentation is required after each activity, prior to proceeding to the next.

The method 200 may then proceed to the mobile device 102 receiving and storing input from the user based on the instructions, as at 216. In some cases, the input may be the user swiping, checking off, or otherwise indicating that an activity was conducted pursuant to the instructions. In other cases, the input may additionally or instead include the user inputting data from one or more of the input peripheral components 102. For example, the instructions at 214 may include typing on a keyboard, or taking a picture of the object. As such, receiving and storing at 216 may include receiving and storing the user indication, text, or picture. In other cases, the instructions provided at 214 may include taking any other type of input data from any other type of the input peripheral components 103, 105, as may be useful in subsequent analysis of the workflow.

FIG. 4 illustrates a display of the mobile device 102, depicting an example of instructing at 214 and receiving at 216, according to an embodiment. As described above, the workflow may include instructions, which may, for example, take the form of a query to the user. Instructions 500, 502, 504, and 506 are examples of such query-based instructions. The user may proceed sequentially through the instructions, or may undertake the instructions in groups, in any sequence within the group. Further, the mobile device 102 may store inputs, and may allow tracking of inputs received using one or more input displays 508, 510, 512, 514 for each instruction. The input displays 508-514 may track input received, input required but not yet received, a combination thereof, or the like. As shown, for example, the input display 508 indicates that one visual input (photograph) has been received, but no audio or text inputs.

Returning to FIG. 2, with an instruction given and the inputs resulting therefrom received and stored, the method 200 may proceed to determining whether to adjust the workflow, as at 218. The determination at 218 may be made by the mobile device 102, for example, using logic embedded in or otherwise associated with the workflow. In other embodiments, the mobile device 102 may transmit results from one or more recent inputs received at 216 to the cloud server 106 for analysis. The cloud server 106 may then determine whether to adjust the workflow, and then send the determination to the mobile device 102. In another implementation, the mobile device 102 may transfer the input data to the computer 104 for the determination of whether to adjust the workflow. However, regardless of whether the mobile device 102 conducts the analysis or requests the analysis be done by another device, the mobile device 102 may be characterized as doing the determining at 218, since it may cause the determination to occur.

If the determination at 218 is affirmative, the method 200 may proceed to the mobile device 102 adjusting the workflow at 220. For example, the determination at 218 may indicate that a failure cause is ruled out, or that a result of the current workflow is likely to be indeterminate with the current activities of the workflow. Accordingly, the mobile device 102, using the logic of the workflow, may adjust the questions to be presented, so as to probe for additional relevant information, forego unnecessary or inapplicable data collection, and/or to instruct the user of the mobile device 102 to take remedial action.

After adjusting at 220, or upon a negative determination at 218, the method 200 may proceed to updating the completion indicator, as at 222. Updating the completion indicator may take into consideration inputs received and activities of the workflow that are completed, at 214 and 216. Further, updating the completion indicator at 222 may consider adjustments to the workflow at 220, if any, which may result in additional or fewer activities remaining in the workflow.

The method 200 may then proceed to determining whether to generate and send a workflow report or any other data collected, for example, to the cloud server 106, for storage, analysis, etc., as at 224. In some embodiments, the workflow reports may be retained in the mobile device 102, e.g., allowing the user of the mobile device 102 exclusive or shared access to the workflow report “in app.” Moreover, the reports may be generated continually whenever new data is received or may proceed according to triggers, which are referred to in FIG. 2 as “report-out milestones.” For example, if a logical section of the workflow has been completed, e.g., the initial teardown is complete, or inspection of one area among several of a structure or machine is complete, the workflow may reach a logical stopping point. In other cases, the trigger or milestone may relate to an amount of data collected, e.g., to avoid losses due to malfunctioning, damage to, etc. the mobile device 102 and/or the computer 104. The cloud server 106 may provide redundancy measures to avoid such loss of data and may thus be a suitable location for large amounts of data that would be time-intensive to recollect. It will be appreciated that such milestone events may occur after input is received for a step, after at a chronological interval, by selection of the user, prior to a shutdown of the mobile device 102, or any at other event or time.

Upon an affirmative determination at 224, the method 200 may proceed to the mobile device 102 generating a report, as at 226. In various embodiments, the report generated at 226 may be a condensed analysis, a summary, or a complete package of the responses, inputs, and other data collected as part of the workflow. In some situations, all inputs collected since the previous report was generated may be included in the report at 226. In other situations, the inputs collected since the previous report may be included in the generated report, with, for example, inputs collected prior to (and/or included in) a previous report being omitted from the current report. After generating the report at 226, the report may be transmitted as at 228, e.g., to the cloud server 106. In turn, the cloud server 106 may analyze the report and/or store the report in the application database 112, as will be described in greater detail below.

After transmitting the report at 228, or upon a negative determination at 224, the method 200 may proceed to determining whether the workflow is complete, as at 230. Determining whether the workflow is complete may include considering whether additional activities of the workflow remain uncompleted. In some cases, this determination may be made by checking the data represented by the completion indicator. If the data represented by the completion indicator does not indicate that all of the activities are complete, the determination at 230 may be negative, and affirmative otherwise. In some cases, the user may be prompted to indicate whether any subsequent actions are desired, prior to the workflow being considered complete.

Upon a negative determination at 230, the method 200 may include the mobile device 102 moving to the next activity of the workflow and returning back to instructing and collecting data, as described above. Thus, this loop, including, e.g., 214-230, may repeat as many times as necessary until the workflow is complete or otherwise terminated. In some embodiments, at any time, the user of the mobile device 102 may stop the workflow. The workflow, including inputs received, may be stored on the mobile device 102, with the stored workflow being transmitted or synchronized or “synced” with the computer 104, the cloud server 106, or another device, for access at a later time. With the workflow stopped and saved, the user may select another workflow, whether new or previously partially completed, and begin or resume the other workflow. In some embodiments, the user may also revise the inputs of the previous workflows, for example, to add additional inputs to document activities previously completed.

When the mobile device 102 determines that the workflow is complete at 230, the mobile device 102 may generate a final report, if the last report generated at 226 is insufficient. Thereafter, the mobile device 102 may wait for an indication of responsive actions to be taken, as at 232, based on the results of the workflow. Responsive actions may depend on the goal of the workflow, and may include instructions, e.g., to bring operation into compliance, order new parts or products, to apply for standardization certifications, etc.

Turning now to the operation of the cloud server 106, FIG. 5 illustrates a flowchart of a method 500 for collecting and managing data, according to an embodiment. Although described with reference to the cloud server 106, it will be appreciated that the method 500 may proceed by operation of any suitable computing system, and is not limited to any particular structure, unless otherwise expressly stated herein. Furthermore, in one or more embodiments, at least some of the operations described herein with reference to the cloud server 106 may instead or additionally be conducted by the mobile device 102, the computer 104, a combination thereof, servers or other computing devices linked to the cloud server 106, and/or the like.

In an embodiment, the method 500 may begin by receiving a request from a remote device, e.g., the mobile device 102 and/or the computer 104, for a workflow, as at 502. The request may include data indicative of a certain object upon which the workflow is to be conducted, as well as a stated goal of the workflow. The request may also include information indicating input peripheral components 103, 105 available for use in collecting data in a workflow. The cloud server 106 may interpret this data and access the workflow database 116 storing a plurality of such workflows, as at 504.

In some embodiments, the cloud server 106 may combine the data incorporated into the request for a workflow with data stored in the application database 112, to assist in accurate selection of workflows. For example, each index of the application database 112 may include information relating to an operating environment associated with the mobile device 102. Thus, the index of the application may store data indicative of an operation system of the mobile device 102, a version of the application executing thereon, equipment associated with the mobile device 102 (e.g., owned/operated by the owner/operator of the mobile device 102), input peripheral components 103, 105 available to the user of the mobile device 102, the manufacturer of such equipment, operating conditions previously recorded, previously-conducted workflows, and any other data that may be relevant.

An index of the master database 120 may also be initialized, for example, including the application information of the appropriate index of the application database 112, or an address, pointer, or link thereto. Further, each index of the workflow database 116 may contain information that can be matched to a request to identify an appropriate workflow, as well as providing activities and/or logic for adjusting a “non-linear” workflow in response to inputs received during implementation. Accordingly, each index of the workflow database may include a product or object type to which the workflow applies, a set of instructions, inputs required, identification of relevant structure, machine, or other object components, and/or any other relevant data.

The method 500 may then proceed to the cloud server 106 determining if the search for a workflow with the desired characteristics is found, as at 506. If no workflow is found, i.e., the determination at 506 is negative, the method 200 may proceed to the cloud server 106 transmitting a request for adjusted workflow parameters, as at 507. In another embodiment, the cloud server 106 may find one or more nearest matches for the desired workflow, and send the nearest match or matches to the mobile device 102 for selection by the user. If the user disapproves of the nearest matches, the user may be prompted for adjusted workflow parameters.

In some embodiments, if the workflow desired does not exist, the method 500 may include building a new workflow. For example, the workflow parameters (e.g., object and stated goal) may be transmitted to an application factory. One or more workflow developers, whether automated or human, may then create the desired workflow. In an embodiment, the application factory may send a builder workflow to the mobile device 102, with the builder workflow containing instructions and/or logic to harvest additional details, requirements, etc. of the new workflow. The workflow may be completed, e.g., as described above with reference to FIG. 2, as with any other workflow, with the results being employed to assemble a new workflow. Thereafter, the new workflow may be stored in the workflow database 116, and implemented as part of the methods 200, 500.

On the other hand, if the determination at 506 is positive, e.g., a match is found, an identifier associated with the appropriate index of the workflow database 116 (i.e., associated with the selected or matching workflow) may be loaded into the index of the master database 118, with the record identifier. Accordingly, each index of the master database 118 may include or link to a record identifier associated with the workflow request, a selected workflow from the workflow database, and an appropriate index of the input database 114 where substantive data from the workflow reports may be stored.

Further, upon a positive determination 506, the appropriate workflow data (e.g., instructions, required inputs, logic for adjusting non-linear workflows) may be transmitted to the remote device (e.g., the mobile device 102 and/or computer 104), as at 508. In some embodiments, the entirety of the workflow may be transmitted at once for implementation by the mobile device 102 and/or the computer 104. In other instances, the workflow may be broken up into sections, with each section being released after a previous section is completed.

After transmitting the workflow at 508, the method 500 may proceed to the cloud server 106 waiting for, and eventually receiving, a workflow report from the remote device (e.g., the mobile device 102), as at 510. When the workflow report is received, the cloud server 106 may take actions to store and/or analyze the workflow report and any data, e.g., inputs from the one or more input peripheral components 103, 105 included or attached to the workflow report.

The cloud server 106 may employ the input database 114 and the master database 118 to perform such storing and/or analysis. For example, the workflow report may include the record identifier stored after receiving the request in the index of the master database 118. The cloud server 106 may then access the input database 114 and initialize a new index, associated with the record identifier. Accordingly, as a workflow report is received, any input associated therewith may be represented or otherwise stored in the index of the input database 114 with the matching record identifier. Further, each index of the input database 114 may include notes, analysis, etc. which may be generated automatically in response to the workflow report, by interaction with one or more engineers or other personnel accessing the cloud server 106, and/or provided by the user of the mobile device 102, e.g., as part of the workflow report. The data in the index of the input database 114 may thus be compared to the data required in the index of the workflow database 116, so as to determine, for example, the level of completeness of the workflow.

Once having received the workflow report, the method 500 may proceed to the cloud server 106 determining whether the workflow is incomplete, as at 512, i.e., whether the workflow report represents a final report. If the determination at 512 is negative, then the workflow report may be indicative of an incomplete workflow. In such case, the cloud server 106 may analyze the workflow report and determine if any workflow adjustments are beneficial, as at 514 and, if they are, update or otherwise adjust the workflow as at 516 and transmit the updated workflow back to the mobile device 102 at 508. The determination of when and how to adjust the workflow at 516 may proceed according to logic associated with the workflow, and may proceed similarly to the adjustment determination at 218, as described above with reference to FIG. 2. For example, the workflow report may indicate that a particular failure cause is ruled out, ambiguous, or identified as a possibility; accordingly, in a failure analysis workflow, the cloud server 106 may identify additional information that may be configured to determine other potential causes, probe for additional input to confirm or rule out the cause, and/or take corrective actions. Similarly, the inspection workflow adjustment may proceed to finding additional details, providing compliance instructions, etc. Moreover, the determination at 514 may be indicative of an updated or newer version of the workflow being available. Accordingly, the method 500 may include the cloud server 106 pushing updated workflows seamlessly to the mobile device 102, even after the mobile device 102 is already engaged in implementing a workflow.

If the determination at 514 is negative, the method 500 may proceed to determining whether the workflow remains the most appropriate workflow, or whether an alternative workflow is more suitable, as at 518. For example, if the workflow report received at 510 is indicative of an object being analyzed which is other than the object associated with the workflow, another workflow may be more appropriate. In another case, if an inspection workflow indicates a safety hazard, another standards compliance issue, proceeding toward an inapplicable standard, or any other issue, other workflows may be deemed more suitable for current implementation. If such a determination at 518 is affirmative, the method 500 may proceed to the cloud server 106 adjusting the workflow parameters at 520 and then, for example, searching for a new workflow to substitute for the current workflow.

On the other hand, if the determination at 518 is negative, it may be indicative that no adjustments are needed, as determined at 514, and no alternative workflows are more suitable, as at 518, and thus the cloud server 106 may store, analyze, or take any other actions suitable for the workflow report generated in the incomplete workflow, and then wait for the next workflow report, as at 522.

Returning to the determination of whether the workflow is complete at 512, i.e., whether the workflow report is a final report for the workflow, when the determination is affirmative, the method 500 may proceed to the cloud server 106 identifying one or more potentially-interested entities 122-126 based on the workflow, the workflow report, the object, other factors, or a combination thereof, as at 524. Such a determination may include the cloud server 106 searching the entity database 120.

The entity database 120 may include fields matching potentially-interested entities 122-126 with workflows, equipment types, manufacturers, applications, etc. For example, one potentially-interested entity 122-126 may be an appropriate entity to address high-speed bearing part failures for a particularly manufacturer. Accordingly, if a workflow is associated with failures, high-speed bearings, and/or the particular manufacturer, the potentially-interested entity may be matched to the workflow. In some embodiments, the search of the entity database 120 may identify more than one potentially-interested party. In such cases, the cloud server 106 may rank the matches, based on the number or importance of the matches, heuristics, or any other data, to identify a most relevant potentially-interested entity 122-126. Additionally or alternatively, the cloud server 106 may request a user of the mobile device 102 to select one of the matches, or may consider all matches as identified potentially-interested entities 122-126. As noted above, the potentially-interested entities 122-126 may be engineering or product groups, vendors, business groups, compliance groups, standards regulators, and/or the like.

With the potentially-interested entities 122-126 identified, the method 500 may proceed to the cloud server 106 transmitting the workflow report to the one or more of the potentially interested entities 122-126 identified, as at 526. Such transmission may be over email, text, automated telephone or voicemail, or any other medium. Similarly, such transmission may proceed by posting the workflow report, or an indication thereof, to a rendezvous/distribution point (e.g., website) and notifying the potentially-interested entities 122-126 identified of the availability of the workflow report.

In some cases, one or more of the identified potentially-interested entities may receive and analyze the workflow report and determine a course of action to take based upon the workflow report. For example, analysis of the workflow report may indicate that ordering a new part, conducting training, auditing operating conditions and/or machine configurations, issuing a certification, or any other action is required or recommended based on the workflow report. In some cases, however, no action may be necessitated by the workflow report; rather, the workflow report may be simply be a result of a reporting requirement that, once completed satisfactorily, does not warrant additional action.

When a responsive action is identified by one or more of the entities 122-126, the one the entities 122-126 may respond with a responsive or recommended action. In some embodiments, the cloud server 106 may receive this action, as at 528, and may act as an intermediary, retransmitting the response to the user of the mobile device 102 and/or the computer 104. In other embodiments, the identified potentially-interested entities may query the cloud server 106, e.g., for contact information associated with the application, which may be stored the application database 112. In other cases, the potentially-interested entities may respond by indicating that the workflow report is deficient of information in some regard. In the deficiency is due to one or more activities lacking in the workflow, the workflow may be adjusted to avoid a reoccurrence of the same deficiency. Further, instructions for collecting the missing data may be transmitted to the mobile device 102, so as to cure the deficiency. In still other embodiments, the responsive action received at 528 may indicate an action for the cloud server 106 to take, such as, for example, directing the user of the mobile device 102 to conduct a purchase of a part, product, service, etc.

In some circumstances, such responsive action may be substituted or augmented with the cloud server 106 providing one or more reports to the mobile device 102, computer 104, or another device. Such reports may provide, for example, metrics, benchmarks, baselines, or specific mapping of opportunities, compliance rates, or other information that may be useful to a particular user. Accordingly, it will be appreciated that, in some cases (i.e., in some workflows, when a user opts-out of referring information to outside entities or does not opt-in for such referring) referring information to one or more potentially-interested entities 122-126 may be omitted.

### EXAMPLES

The foregoing generalized description of the system 100 and methods 200, 500 may be better understood with reference to one or more specific examples. However, it is to be understood that these examples are but a few among many embodiments of the system 100 and/or methods 200, 500 that may be implemented, and are thus not to be considered limiting unless otherwise expressly stated herein.

### Example 1

### Failure Analysis

The system 100 may be configured for use in a failure analysis context, e.g., for a machine. In a failure analysis context, it may be desirable to control the state of the machine, before and/or while it is disassembled to expose the broken part. This may provide insight, analogous to a forensic analysis, into the cause of the failure and mitigate a risk of reoccurrence.

Referring now to FIG. 2, the failure analysis example may be illustrated by reference to the method 200 described above. The method 200 may begin, prior to teardown of the failing/failed machine, by receiving the input, at 202, which may indicate a suspected or observed failure of a particular part. The mobile device 102 may then query the user as to the goal of the workflow, as at 204, which may be, in this case, identification of and remediation of a failure.

The mobile device 102 may then search a database to match the machine, part failure, and/or the goal to identify and/or remediate a failure to a suitable workflow, as at 206. In some cases, this may be conducted by sending the workflow parameters in a request to the cloud server 106, as will be described in greater detail below. In other cases, the search at 206 may be conducted by the mobile device 102, the computer 104, the cloud server 106, or another device.

The mobile device 102 may then determine if a matching workflow is found. If one is not found, or could not be built implementing a builder workflow, as described above, the mobile device 102 may loop back to querying the user for additional and/or adjusted workflow parameters. If an appropriate workflow is found, the mobile device 102 may indicate to the user a list of resources, documentation, input peripherals etc. that are required to perform the failure analysis workflow, as at 210. Further, the mobile device 102 may display a dynamic completion indicator, as at 212.

With the failure analysis workflow initialized on the mobile device 102, the mobile device 102 may proceed to instructing the user to carry out the first activity of the workflow, as at 214. The first activity may be to document the operation and/or other conditions of the machine prior to teardown. Such instructions may include using various input peripheral components 103 (and/or 105) such as one or more of the sensors or probes described above, and/or a camera, video, microphone, or any other peripheral to document the relevant conditions. In some cases, the activity may include answering a query, e.g., as to the state of the machine, the suspected or observed failed part, or any other conditions.

The mobile device 102 may then receive and store input received in response to the instruction at 214, e.g., using internal memory of the mobile device 102, as at 216. The input may include data captured from the input peripheral components 103, 105, query answers entered by a keyboard, mouse, and/or gesture (e.g., swipe) on a touchscreen. Based on the input, the mobile device 102 may apply logic, e.g., logic contained, embedded, or otherwise associated with the workflow to determine whether to adjust the workflow in response to the input, as at 218. For example, if an operating condition suggests one or a set of failure causes have an increased likelihood, the workflow may be adjusted to focus in the failure cause(s) that are likely. The adjustments to the workflow may also be remedial, for example, adding instructions to adjust operating conditions or machine configuration to address the cause of the failure and attenuate a risk of reoccurrence.

After adjusting the workflow at 220, or determining that no adjustments are required at 218, the method 200 may include updating the completion indicator at 222. This may take into consideration that one or more of the instructions have now been completed and/or any instructions that have been removed or added by any workflow adjustment at 220.

The method 200 may proceed to determining if a report trigger or milestone is reached at 224. For example, a milestone may be that the initial, pre-teardown operation conditions are fully documented. If a milestone is reached, the method 200 may proceed to the mobile device 102 generating and transmitting a report, at 226 and 228, respectively, for example, to the cloud server 106. In other cases, the milestone determination may be made upon a shutdown of the mobile device 102, computer 104, or any other trigger, such that the mobile device 102 transmits information or “syncs” with the cloud server 106, the computer 104, or both. Furthermore, the cloud server 106 may receive the workflow report transmitted at 228 and adjust, terminate, or otherwise interrupt the workflow. For example, if a new failure analysis workflow is released, the cloud server 106 may push the updated workflow to the mobile device 102, which may change the instructions, logic, or other aspects of the workflow being implemented. In some cases, this pushing of the new workflow may be seamless and may occur while the user is implementing the workflow and may proceed as part of the sync with the mobile device 102.

The method 200 may then proceed to determining whether the workflow is complete. This may proceed by determining if the last instruction has been given and/or if all necessary inputs have been received. Further, the cloud server 106 may recognize that a cause of the failure has been identified, without requiring further failure analysis data, and may thus signal to the mobile device 102 that the workflow is completed. In this example case, the instructions to this point may have been related to documenting operating conditions; therefore, unless the operating conditions indicate a failure cause, the workflow may be indicated as incomplete.

As such, implementing the failure analysis workflow, the method 200 may include the mobile device 102 looping back to providing the next instruction to the user, as at 214. For example, the next instruction may be to begin a first or next increment of the teardown, and to document one or more aspects of the machine and/or inputs associated with the teardown activity. The inputs may be received in response to these instructions, as at 216. The method 200 may then repeat the process of adjusting the workflow at 220 if determined to be necessary at 218, updating the completion indicator, generating and transmitting a workflow report, at 226 and 228, respectively, if determined necessary at 224. The method 200 may then loop back to providing instructions for the next activity, at 214, and receiving input at 216 in a guided fashion until the workflow is complete. Accordingly, a controlled, guided environment may be provided for documenting the complete circumstances surrounding a failure may be provided.

The final report may be transmitted at 228. With the workflow determined to be complete at 230, the mobile device 102 may wait for an analysis with responsive actions to be received at 232. The responsive actions may be received at 232 from a vendor, maintenance or repair service provider, engineering or business team, or any other suitable and identified interested entity. Moreover, the responsive action may indicate that a new part is required for proper operation. The mobile device 102 and/or the computer 104 may then provide an e-commerce platform (e.g., webpage, application screen, etc.) for the user to order (e.g., purchase) the replacement part. Further, the cloud server 106 may handle the transaction, debiting an account associated with the user, crediting an account associated with the vendor, and sending the purchase order to the vendor for processing. Further, the responsive action may itself include a workflow, e.g., to implement changes to the operating conditions, machine configuration, and/or to install the new part to ensure proper operation. Additionally, the responsive action may specify a training program for one or more machine operator to attend, for example, if improper operating conditions are identified as a potential or actual cause of the failure.

Referring now to FIG. 5, and continuing with the failure analysis, the method 500 may proceed by the cloud server 106 operating in the context of the failure analysis. Accordingly, the cloud server 106 may receive the request from the mobile device 102 for a workflow, as at 502. The cloud server 106 may access the databases 112-120 to find and track an appropriate workflow, as at 504.

FIG. 6 illustrates contents of the databases 112-118 in a failure analysis context, in accordance with the present example. The application database 112, input database 114, and master database 118 may be generally as described above. Accordingly, for example, the input database 114 may include views and notes collected as part of the workflow, e.g., related to the operation or state of the machine prior to tear down, and then incrementally during and/or after each stage of teardown to identify and remove the failure. The workflow database 114 may specifically include incremental disassembly (teardown) instructions, and targeted views required or recommended for completion of the workflow.

Using the information from the request, the application data, and any other relevant data, the cloud server 106 may select an appropriate failure analysis workflow from those stored in the workflow database 116. For example, the failure analysis workflow may be tailored to a particular machine and/or part. The failure analysis workflow may be tailored to a particular operating condition, as the operating condition may affect the likely sources of failure (e.g., common modes and/or sources of failure in land-based operations may be different than those in offshore or harsh climate conditions and/or object/machine age may be a relevant consideration). Such information may be stored in the application database 112. If a suitable workflow is not found, in some cases, one may be built, as described above. In other cases, the cloud server 106 may transmit a request for adjusted operating parameters, as at 507.

When the suitable failure analysis workflow is identified at 506, the method 500 may proceed to transmitting the failure analysis workflow to the mobile device 102, so that the mobile device 102 may implement the failure analysis workflow, as discussed above. After one or more milestone events, the mobile device 102 may “sync” or otherwise exchange data with the cloud server 106. If the workflow is determined to be incomplete, at 512, the cloud server 106 may proceed to determining if the failure analysis workflow should be adjusted, as at 514 or substituted, as at 518. For example, if the inputs (e.g., pictures) received in the workflow report indicate that one or more modes or causes of failure are particularly likely or unlikely, the workflow may be adjusted at 516 to focus on the likely modes or causes. Further, if the workflow reports do not comport with expected inputs, i.e., an earlier identified likely cause of action is now ruled out, or the suspected failed part has not failed (e.g., a different part has failed), or for any other reason, the workflow may be adjusted at 516 or a new workflow may be substituted at 520 and delivered to the mobile device 102, as shown.

When the cloud server 106 determines that the workflow is complete, or otherwise determines that sufficient information exists for an analysis of a workflow report, the method 500 may proceed to the cloud server 106 using data gleaned from the failure analysis workflow, the workflow report, the failed object, or any other data to search the entity database 120. Matching entities 122-126 may be identified and, in some cases, ranked. For example, if the part that failed is a bearing, for a high speed application, with a particular OEM, separate potentially-interested entities 122-126 that may be matches may be vendors of high-speed bearings, service/repair vendors of high-speed machinery, the engineering department of the OEM, etc. Various techniques to identify and/or choose one or more of the potentially-interested entities may be employed, consistent with the present disclosure.

With the potentially-interested entities identified, the method 500 may proceed to transmitting the failure analysis workflow report to the identified potentially-interested entities, as at 526. For example, the engineering department of the OEM may review the failure analysis workflow report to determine if a malfunction is design-based, systematic, due to normal wear and/or life-cycle completion. The part vendor may identify a replacement part for purchase. The service/repair vendor may determine whether and what maintenance and/or repair services may be implemented to avoid reoccurrence of the failure and/or to fix the current failure e.g., by installing the replacement part. A variety of other such vendors and/or interested entities may be considered. Furthermore, the workflow report may be partitioned, analyzed, condensed, or otherwise tailored to the information needs of a particular potentially-interested entity 122-126, such that, if multiple potentially-interested entities are identified, a different report may be sent out to some or each of the entities 122-126. For example, an OEM may require different information, e.g., to determine if operating conditions are off-design and should be adjusted, than a distributor/part vendor, who may be interested in providing the replacement part. Moreover, the failure analysis workflow may be emailed, posted to a distribution/rendezvous point (e.g., webpage), or transmitted to the identified potentially interested entities via any other process and/or communication link.

The method 500 may thus proceed to awaiting, and eventually receiving, a response from the one or more of the entities 122-126, as at 528. For example, the OEM may respond with a corrective action to take to adjust operating conditions and/or by indicating whether a warranty replacement is available. The distributor/part vendor (which may also be the OEM) may respond with a part number, price, location for purchase of the part, etc. The service/repair vendor (which may also be the OEM) may respond with a recommended service, e.g., installation, maintenance, etc. In various embodiments, the cloud server 106 may be responsible for relaying the response received at 528 to the mobile device 102, e.g., via text, email, posting to a distribution site/rendezvous point (e.g., a webpage) or the like. In other embodiments, the cloud server 106 may respond to the entity with contact information for the user of the mobile device 102. In still other embodiments, the cloud server 106 may initiate a purchase, e.g., by relaying an offer from a parts vendor to the user of the mobile device 102. The mobile device user may accept the offer, and the cloud server 106 may debit funds from an account maintained by the user, a bank, etc., and carry out the purchase from the vendor. A similar process may be used for purchasing services, etc., using the cloud server 106.

### Example 2

### Inspection Workflow

An inspection workflow may also be employed using the system 100 and/or the methods 200, 500, according to an embodiment. Such an implementation may be similar to the implementations described above; accordingly, a complete, duplicative description of the system 100 and methods 200, 500 is omitted.

The inspection workflow may be identified per a request and/or using known operating conditions of the mobile device 102 (e.g., by reference to the application database 112). The workflow may then be delivered, the user instructed, inputs received, stored, and workflow reports generated and transmitted, e.g., using the mobile device 102 and/or the cloud server 106 as described above. Each instruction may specify an inspection activity and each input may document the undertaking of such inspection activity and/or the results of the activity. Further, the workflows may be non-linear, i.e., dynamically adjustable, substitutable, etc., as described above, to ensure the proper inspection criteria is applied, and potentially remedial action identified and instructed to be taken.

When the workflow is complete, the inspection workflow report may be passed to one or more standards regulatory authorities, part or machine OEMs (e.g., to determine standards compliances), and/or the like. Such interested entities may respond by identifying remedial action, issuing certifications or qualifications, taking no action, and/or the like.

### Example 3

### Part/Product Identification

Similarly, part or product identification workflows may be implemented using embodiments of the system 100 and/or methods 200, 500. Such identification workflows may have a goal of determining a particular part or product that best suits the operating conditions, machine, structure, application, etc., in which it is to be implemented. Examples of such parts may include bearings, which may each be configured for use in specific conditions. Examples of such products may include lubrication, which similarly may be configured for use in specific conditions. Accordingly, identifying the appropriate part/product may increase life cycles, operational efficiency, reduce cost, etc.

Accordingly, the method 200 may proceed as discussed above, with the identification workflow identified using any relevant initial data, as at 202 and 204. The mobile device 102 may then implement the identification workflow, sequentially instructing the user at 214, collecting input at 216, adjusting the workflow at 220 when deemed appropriate at 218, and reporting results at 228 when deemed appropriate at 224 (among other potential activities, as discussed in greater detail above).

The cloud server 106 may implement an embodiment of the method 500, receiving the request at 502, finding a workflow at 506, transmitting the workflow to the mobile device 102 at 508, and receiving the workflow reports therefrom at 510. The cloud server 106 may adjust the workflow at 516 or find a substitute workflow according to adjusted workflow parameters at 520, e.g., to ensure proper identification, or to take remedial action if appropriate due to an off-design or other condition reported.

With the workflow completed at 512, the cloud server 106 may use the workflow report to determine what products or parts are suitable and identify a potentially-interested entity, e.g., a part or product vendor, a maintenance/installation service vendor, and/or the like. In other cases, the identification workflow may provide raw operational details, which may be forwarded to the entities so that the entities may determine appropriate parts and/or products. In either example case, the cloud server 106 may identify the appropriate entity or entities at 524 and may rank or select among them using any suitable technique. The cloud server 106 may then transmit the workflow report to the one or more entities at 526, and await and eventually receive a response therefrom, as at 528. As with the failure analysis workflow, the response may be to effect a sale of a product, which the cloud server 106 may do by sending an offer to the mobile device 102. Upon acceptance of the offer, the cloud server 106 may debit an account associated with the user of the mobile device 102 and transmit funds to the appropriate vendor.

From the foregoing generalized description and specific example implementations of the system 100 and methods 200, 500, it will be appreciated that the system 100 and methods 200, 500, according to various embodiments, may be implemented in a nearly limitless number of contexts. For example, such non-linear workflows and guided data collection, decision structuring, and provision of information to appropriate entities for response may be useful for audits, certification analyses, inspections, asset mapping, opportunity mapping, field service engineers, machine operators, medical staff, police forces, logistic workers, military, and others. Further, embodiments of the system 100 may integrate a purchasing platform (e.g., via a website) for identified needed products and/or services to be provided from the same location where the need was identified. Furthermore, the present system 100 and methods 200, 500 may implement a variety of functionalities from the use of the workflows (whether linear or non-linear), such as engineering calculators, frequency calculators, lubrication selectors, maintenance, inspections, audits, training, spare part optimizers, and the like. Thus, the workflows may guide a user through collecting the proper information and assist, make, or send out information to a third party for the third party to make, decisions leading to an efficient solution to an engineering need. In at least one specific embodiment, the systems 100 and/or methods 200, 500 may implement or be implemented in an integrated platform such as @PTITUDE® commercially available from SKF Corporation.

Embodiments of the disclosure may also include one or more systems for implementing one or more embodiments of the methods 200, 500 of the present disclosure. FIG. 7 illustrates a schematic view of such a computing or processor system 700, according to an embodiment. The processor system 700 may represent one or more embodiments of the mobile device 102, the computer 104, the cloud server 106, or any other computing device of the system 100. Further, it will be appreciated that in various embodiments, the mobile device 102, computer 104, and/or cloud server 106 may each include multiple processor systems 700, or two or more of the computing systems of the system 100 may be provided by a single processor system 700.

The processor system 700 may include one or more processors 702 of varying core (including multiple core) configurations and clock frequencies. The one or more processors 702 may be operable to execute instructions, apply logic, etc. It may be appreciated that these functions may be provided by multiple processors or multiple cores on a single chip operating in parallel and/or communicably linked together.

The processor system 700 may also include a memory system, which may be or include one or more memory devices and/or computer-readable media 704 of varying physical dimensions, accessibility, storage capacities, etc. such as flash drives, hard drives, disks, random access memory, etc., for storing data, such as images, files, and program instructions for execution by the processor 702. In an embodiment, the computer-readable media 704 may store instructions that, when executed by the processor 702, are configured to cause the processor system 700 to perform operations. For example, execution of such instructions may cause the processor system 700 to implement one or more portions and/or embodiments of the method described above.

The processor system 700 may also include one or more network interfaces 706. The network interfaces 706 may include any hardware, applications, and/or other software. Accordingly, the network interfaces 706 may include Ethernet adapters, wireless transceivers, PCI interfaces, and/or serial network components, for communicating over wired or wireless media using protocols, such as Ethernet, wireless Ethernet, etc.

The processor system 700 may further include one or more peripheral interfaces 708, for communication with a display screen, projector, keyboards, mice, touchpads, sensors, other types of input and/or output peripherals, and/or the like. In some implementations, the components of processor system 700 need not be enclosed within a single enclosure or even located in close proximity to one another, but in other implementations, the components and/or others may be provided in a single enclosure.

The memory device 704 may be physically or logically arranged or configured to store data on one or more storage devices 710. The storage device 710 may include one or more file systems or databases in any suitable format. The storage device 710 may also include one or more software programs 712, which may contain interpretable or executable instructions for performing one or more of the disclosed processes. When requested by the processor 702, one or more of the software programs 712, or a portion thereof, may be loaded from the storage devices 710 to the memory devices 704 for execution by the processor 702.

Those skilled in the art will appreciate that the above-described componentry is merely one example of a hardware configuration, as the processor system 700 may include any type of hardware components, including any necessary accompanying firmware or software, for performing the disclosed implementations. The processor system 700 may also be implemented in part or in whole by electronic circuit components or processors, such as application-specific integrated circuits (ASICs) or field-programmable gate arrays (FPGAs).

The foregoing description of the present disclosure, along with its associated embodiments and examples, has been presented for purposes of illustration only. It is not exhaustive and does not limit the present disclosure to the precise form disclosed. Those skilled in the art will appreciate from the foregoing description that modifications and variations are possible in light of the above teachings or may be acquired from practicing the disclosed embodiments.

For example, the same techniques described herein with reference to the processor system 700 may be used to execute programs according to instructions received from another program or from another processor system altogether. Similarly, commands may be received, executed, and their output returned entirely within the processing and/or memory of the processor system 700. Accordingly, neither a visual interface command terminal nor any terminal at all is strictly necessary for performing the described embodiments.

Likewise, the steps described need not be performed in the same sequence discussed or with the same degree of separation. Various steps may be omitted, repeated, combined, or divided, as necessary to achieve the same or similar objectives or enhancements. Accordingly, the present disclosure is not limited to the above-described embodiments, but instead is defined by the appended claims in light of their full scope of equivalents. Further, in the above description and in the below claims, unless specified otherwise, the term “execute” and its variants are to be interpreted as pertaining to any operation of program code or instructions on a device, whether compiled, interpreted, or run using other techniques.

What is claimed is:

1. A computing system, comprising:
a server comprising a processor and being configured to communicate with a plurality of remote devices via a network;
an application database accessible to the server and comprising application indices, wherein, at each of the application indices, the application database stores information related to an operating environment of one of the plurality of remote devices;
a workflow database accessible to the server and comprising workflow indices, wherein, at each of the workflow indices, the workflow database stores a workflow, the workflow comprising activities and required inputs;
an input database accessible to the server and comprising input indices, wherein, at each of the input indices, the input database stores input received from at least one of the plurality of remote devices executing a workflow; and
a master database accessible to the server and comprising master indices, wherein at each of the master indices, the master database stores information linking one of the input indices of the input database with one of the plurality of remote devices and with one of the workflow indices of the workflow database.

2. The system of claim 1, further comprising an entity database accessible to the server and comprising entity indices, wherein, at each of the entity indices, the entity database stores information related to one or more potentially-interested entities and an object of the workflow, a workflow goal, a workflow result, or a combination thereof that is relevant to the one or more potentially-interested entities.

3. The system of claim 2, wherein the server further comprises a memory system comprising one or more computer-readable media storing instructions that, when executed by the processor, are configured to cause the server to perform operations, the operations comprising:
receiving a workflow report indicating an object that was analyzed using a workflow, a goal of the workflow, a result of the workflow, or a combination thereof;
searching the entity database using the workflow report to identify one or more potentially-interested entities; and
transmitting data based on the workflow report to the one or more potentially-interested entities that are identified.

4. The system of claim 3, wherein the operations further comprise determining that the workflow is complete prior to transmitting the data based on the workflow report to one or more potentially-interested entities.

5. The system of claim 3, wherein the operations further comprise:
receiving a responsive action from at least one of the one or more potentially-interested entities; and
transmitting the responsive action to one or more of the plurality of remote devices.

6. The system of claim 1, wherein the workflow stored in at least one of the workflow indices of the workflow database includes instructions that, when executed, are configured to cause the server, the remote device, or both to evaluate one or more inputs and adjust the workflow.

7. The system of claim 1, wherein the server further comprises a memory system comprising one or more computer-readable media storing instructions that, when executed by the processor, are configured to cause the server to perform operations, the operations comprising:
receiving a workflow request from the remote device, wherein the workflow request includes one or more workflow parameters;
associating the remote device with at least one of the application indices of the application database;
storing in the master database an identifier indicating the at least one of the application indices;
selecting one of the workflows from the workflow database, wherein the one of the workflows is associated with at least one of the workflow indices;
storing in the master database, an identifier indicating the at least one of the workflow indices associated with the one of the workflows that is selected;
initiating a new index of the input indices of the input database;
storing, in the master database, an identifier indicating the new index of the input database;
transmitting the workflow selected to the remote device;
receiving a workflow report from the remote device after the remote device executes at least a portion of the workflow, wherein the workflow report includes inputs received during the at least a portion of the workflow; and
storing the inputs received in the new index of the input database.

8. The system of claim 7, wherein the operations further comprising:
receiving an updated version of the workflow transmitted to the remote device; and
transmitting the updated version of the workflow to the remote device and instructions configured to cause the remote device to substitute or update the workflow using the updated workflow.

9. The system of claim 7, wherein the operations further comprise:
adjusting the workflow to generate an adjusted workflow, based on the workflow report that is received; and
transmitting the adjusted workflow to the remote device.

10. The system of claim 7, wherein the operations further comprise:
determining, using the workflow report, to substitute the workflow transmitted to the remote device with a second workflow; and
transmitting the second workflow to the remote device for substitution of the workflow.
